(19) United States
(12) Patent Application Publication
(10) Pub. No.: US 2019/0087484 A1
(43) Pub. Date: Mar. 21, 2019

(54) CAPTURING CONTEXT USING NETWORK VISUALIZATION

(71) Applicant: SAP SE, Walldorf (DE)

(72) Inventors: Jaison Jacob, Kollam District (IN); Santhosh Rao, Bangalore (IN); Gonda Marcusse, Kronau (DE); Naveed Mohammed, Bangalore (IN); Apoorv Bhargava, Bangalore (IN); Ismail Basha, Bangalore (IN); Vishnu Kare, Kurnool (IN)

(21) Appl. No.: 15/705,365

(22) Filed: Sep. 15, 2017

(51) Int. Cl. G06F 17/30; H04L 29/08; G06F 3/0481

(52) U.S. Cl. CPC G06F 17/30604; H04L 67/36; G06F 3/04842; H04L 67/22; H04L 67/18; G06F 3/0481

(57) ABSTRACT

Provided are devices and methods for generating and capturing context related to a situation using a network visualization. In one example, the method includes identifying a plurality of entities that are associated with each other based on a common situational event and generating a plurality of nodes representing the plurality of entities, determining relationships between the plurality of entities based on respective attributes of each of the plurality of entities with respect to the common situational event, generating context between the plurality of entities by generating a network visualization including the plurality of nodes linked together based on the determined relationships between the plurality of entities, and outputting the network visualization including the plurality of nodes linked together based on the determined relationships to a user interface.

### BACKGROUND

When solving complex scenarios involve multiple entities, objects, geographical locations, places, and/or the like, it can be difficult to keep track of the entities and their relationships with respect to one another. Some complex situations often involve dozens if not hundreds of moving components that are somehow interrelated. For example, a first entity and a second entity may not be directly related to one another, however, they may be related to one another through one or more intermediate entities, objects, locations, and/or the like. Establishing relationships between these entities through text and other data gathering alone can be difficult because it is difficult to keep track of the various intermediate components and their relationships with each entity.

An example of a process that typically involves the need to solve complex scenarios is an investigation (e.g., criminal, accounting, science, engineering, etc.). Investigations often involve multiple entities (e.g., people, organizations, tasks, etc.) that are interrelated to one another through various attributes (e.g., crimes, locations, technologies, medical data, and the like). For example, a criminal investigation typically attempts to link together a person or a group of persons responsible for a crime that has been committed. However, establishing proof of why or how a person committed the crime can be a daunting task. A criminal investigator often must put together a number of clues or pieces of evidence based on years of training to arrive at a suspect. Furthermore, the investigator often must provide this information to another (e.g., a jury, a judge, an attorney, etc.) that does not have such training or expertise.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIGS. 1A-1B are diagrams illustrating examples of a database system in accordance with example embodiments.

FIG. 2 is a diagram illustrating context of a situation represented by a network visualization in accordance with an example embodiment.

FIG. 3 is a diagram illustrating an example of capturing the context based on the network visualization in accordance with an example embodiment.

FIG. 4 is a diagram illustrating subsequent context of the situation represented by an updated network visualization in accordance with an example embodiment.

FIG. 5 is a diagram illustrating an example of a user selecting a node on a previously captured pattern visualization in accordance with an example embodiment.

FIG. 6 is a diagram illustrating a previously captured pattern visualization being distinguished in a network visualization in accordance with an example embodiment.

FIG. 7 is a diagram illustrating a method for capturing context using a network visualization in accordance with an example embodiment.

FIG. 8A is a diagram illustrating a method of populating a database with context from a network visualization in accordance with an example embodiment.

FIG. 8B is a diagram illustrating a method of providing a user with previously captured context in accordance with an example embodiment.

FIG. 9 is a diagram illustrating a computing system for capturing context using a network visualization in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments relate to a user interface system capable of visualizing context related to a complex situation or complex scenario. The system can generate a network visualization representing the context, and display the network visualization via the user interface. Furthermore, the system can capture the context by saving the network visualization for future exploration and comparison as time passes and the context changes providing the user a point of reference that can be easily discerned from a future state of the context. The network visualization may also be used as legal proof of a determination made by a comprehensive investigation involving multiple entities and attributes associated with the scenario. Users may add information to the system (e.g., people, places, events, etc.) and further define the network visualization. As a result, the network visualization may continue to evolve based on information entered by different users.

A network visualization may include a diagram representing a set of entities exhibiting linear as well as non-linear relationships. The entities may be graphically represented as nodes (entities) connected with lines (relationships). Entities may represent people, organizations, objects, and the like. The network visualization may be used to indicate when a node is related to one or more other nodes. Furthermore, a node can include one or more sub-nodes that exist between another node or group of nodes. The sub-nodes can contain more nodes, and so on. Via commands on the user interface, a user can either expand or collapse nodes to examine (e.g., probe) relationship paths based on the question the user is trying to find answers to.

As more information is added to a network visualization, the visualization and the underlying context evolves and changes its shape, size, and patterns. The evolution can create problems to users because users may not be able to remember/locate specific nodes of interest as the nodes are shuffled and moved around due to new nodes being added to the network visualization. The context visualization system described herein is able to keep track of the nodes, and how their relationships evolve over time, thereby generating information that can be used for future insights. For example, when a user (e.g., an investigator) must make a decision in order to solve a real world problem such as an investigation, the user may capture a pattern of the network visualization which helped the user arrive at the decision, as a legal proof.

The context visualization system may capture the current context of represented by the network visualization along with a time stamp for future reference. The context capture may be used to assist the user understand the evolution of the network visualization over a period of time. The user interface may also provide a panel or window that allows a user to record their insights in the form of synopsis, along with the captured pattern to further aid the user in recollecting the past events. The synopsis also helps the user in sharing these patterns of network visualization with others enabling the user to communicate the context in a much easier way. In addition, the user can also locate all the nodes from the captured pattern on the network by simply clicking on it. This further helps the user in comparing and understanding the growth of the network.

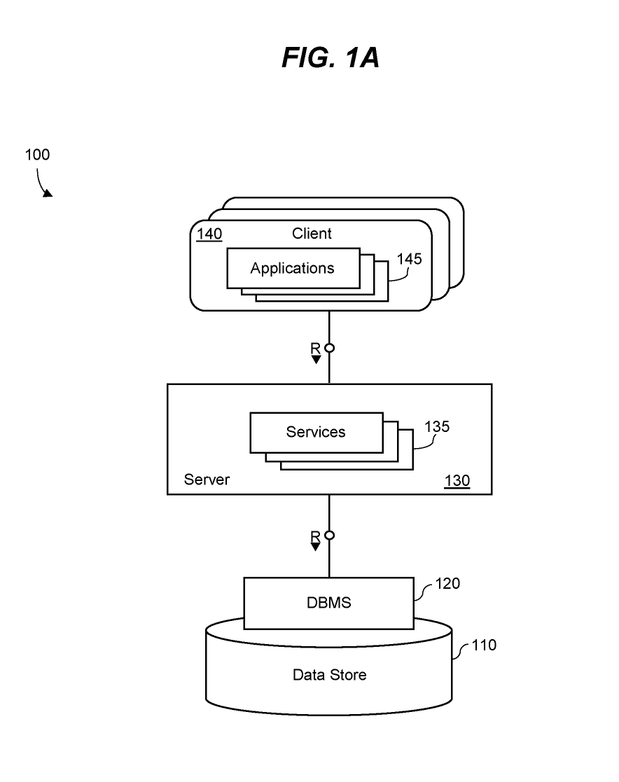

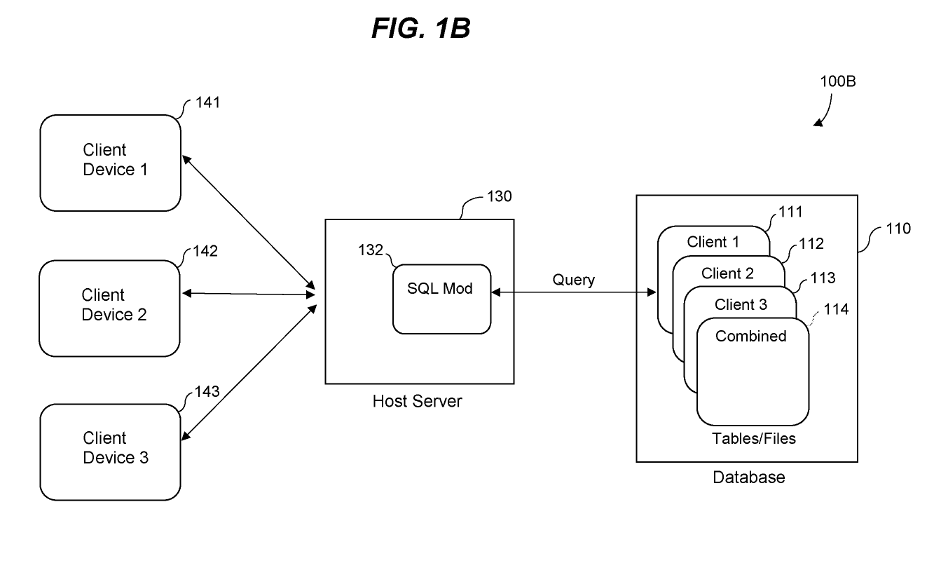

FIG. 1A illustrates a database system architecture 100 for executing a context visualization application in accordance with an example embodiment. It should be appreciated that the embodiments are not limited to architecture 100 or to a database architecture, however, FIG. 1 is shown for purposes of example. Referring to FIG. 1, the architecture 100 includes a data store 110, a database management system (DBMS) 120, a server 130, services 135, clients 140 and applications 145. Generally, services 135 are executed by server 130 and receive requests from applications 145 executed by clients 140 and provide results to the applications 145 based on data stored within data store 110. For example, the server 130 may execute and provide services 135 to applications 145 such as an application for context visualization as described herein. Services 135 may comprise server-side executable program code (e.g., compiled code, scripts, etc.) which provide functionality to applications 145, for example, by providing user interfaces to clients 140, receiving requests from applications 145 (e.g., drag-and-drop operations), retrieving data from data store 110 based on the requests, processing the data received from data store 110, providing the processed data to applications 145, and the like.

In one example, an application 145 corresponds to a context visualization application. In this example, a client 140 may execute the context visualization application to generate a user interface that can be displayed via a display of the client 140 which allows the user to enter information about a case or other scenario such as entities, locations, objects, times, and the like. The context visualization application may pass the entered information based on the input to one of services 135. An SQL script may be generated based on the request and forwarded to DBMS 120. DBMS 120 may execute the SQL script to return a result set based on data of data store 110, and the application 145 may create a report/visualization based on the result set. As another example, the entered information input by the user may be provided directly from the application to the DBMS 120 or the data store 110.

The services 135 executing on server 130 may communicate with DBMS 120 using database management interfaces such as, but not limited to, Open Database Connectivity (ODBC) and Java Database Connectivity (JDBC) interfaces. These types of services 135 may use Structured Query Language (SQL) to manage and query data stored in data store 110. The DBMS 120 serves requests to query, retrieve, create, modify (update), and/or delete data of data store 110, and also performs administrative and management functions. Such functions may include snapshot and backup management, indexing, optimization, garbage collection, and/or any other database functions that are or become known.

Server 130 may be separated from or closely integrated with DBMS 120. A closely-integrated server 130 can enable execution of services 135 completely on the database platform, without the need for an additional server. For example, server 130 may provide a comprehensive set of embedded services which provide end-to-end support for Web-based applications. The services 135 may include a lightweight web server, configurable support for Open Data Protocol, server-side JavaScript execution and access to SQL and SQLScript. Server 130 may provide application services (e.g., via functional libraries) using services 135 that manage and query the data of data store 110. The application services can be used to expose the database data model, with its tables, views and database procedures, to clients 140. In addition to exposing the data model, server 130 may host system services such as a search service.

Data store 110 may comprise any query-responsive data source or sources that are or become known, including but not limited to a structured-query language (SQL) relational database management system. Data store 110 may include a relational database, a multi-dimensional database, an Extensible Markup Language (XML) document, or any other data storage system storing structured and/or unstructured data. The data of data store 110 may be distributed among several relational databases, dimensional databases, and/or other data sources. Embodiments are not limited to any number or types of data sources. In some embodiments, the data of data store 110 may include one or more of conventional tabular data, row-based data, column-based data, object-based data, and the like. Furthermore, the data may be indexed and/or selectively replicated in an index to allow fast searching and retrieval thereof. Data store 110 may support multi-tenancy to separately support multiple unrelated clients by providing multiple logical database systems which are programmatically isolated from one another.

The architecture 100 may include metadata defining database objects which are mapped to logical entities of data store 110. The metadata be stored in data store 110 and/or a separate repository (not shown). The metadata may include information regarding dimension names (e.g., country, year, product, etc.), dimension hierarchies (e.g., country, state, city, etc.), measure names (e.g., profit, units, sales, etc.) and any other suitable metadata. According to some embodiments, the metadata includes information associating users, queries, query patterns and visualizations. The information may be collected during operation of system and may be used to determine a visualization to present in response to a received query, and based on the query and the user from whom the query was received.

Each of clients 140 may include one or more devices executing program code of an application 145 for presenting a user interface to allow interaction with application server 130. The user interfaces of applications 145 may comprise user interfaces suited for visualizing context of a given case or situation via a network visualization and/or any other functions based on the data of data store 110. Presentation of a user interface as described herein may include any degree or type of rendering, depending on the type of user interface code generated by server 130. For example, a client 140 may execute a Web Browser to request and receive a Web page (e.g., in HTML format) from application server 130 via HTTP, HTTPS, and/or Web Socket, and may render and present the Web page according to known protocols. One or more of clients 140 may also or alternatively present user interfaces by executing a standalone executable file (e.g., an .exe file) or code (e.g., a JAVA applet) within a virtual machine.

FIG. 1B illustrates an example of a system 100B in which a plurality of client devices 140 access a shared network visualization software hosted by a server 130, in accordance with an example embodiment. FIG. 1B further provides an additional example of the system 100A of FIG. 1A. In this example, the system 100B includes a plurality of client devices 141, 142, and 143 which access the shared network visualization software being executed by or managed by host server 130. Also, information/context added by each user (i.e., clients 141-143) may be stored on a user-by-user basis in database 110. In this example, each client has one or more database tables 111-113 associated therewith. For example, each user may have their own dedicated file, page, table, etc. or dedicated partition within a file, which includes context the user has added to a particular network visualization related to a situational event. The database 110 may also store a combined network visualization file 114 that includes aggregated context added by the group of clients 141-143 and also includes the most-up-to-date representation of the context of the situational event. As a non-limiting example, the server 130 may include an SQL module 132 configured to query the database 110 to retrieve data from tables 111-114. In some cases, the SQL module 132 may query the database 110 directly, or via the DBMS 120 shown in FIG. 1A.

According to various embodiments, when client 141 access the network visualization software being hosted by server 130, the server may identify the client 141 and the SQL module 132 may access client file 111 associated with the client 141 and also access the combined file 114, from database 110, to retrieve information previously submitted by the respective client 141 and a combined network visualization about a current situational event being viewed by the client 141. For example, the database 110 may access the client file 111 or other storage space dedicated to the client 141 and retrieve the information previously submitted and captured by the client 141 through the network visualization software. The user-added previously captured context may be displayed as miniature patterns or diagrams that have a reduced and more convenient size within the user interface. The miniature patterns may be displayed next to or adjacent to a display of a current or most-up-to date network visualization of the situational event. Here, the client 141 may select a previously captured miniature pattern and the server 130 may visually differentiate the previously captured pattern of the client 141 within the current network visualization which may include contributions from all clients 141, 142, and 143. Accordingly, the client 141 can quickly identify the context that they previously provided as well as context that has subsequently been added by one or more other clients 142 or 143.

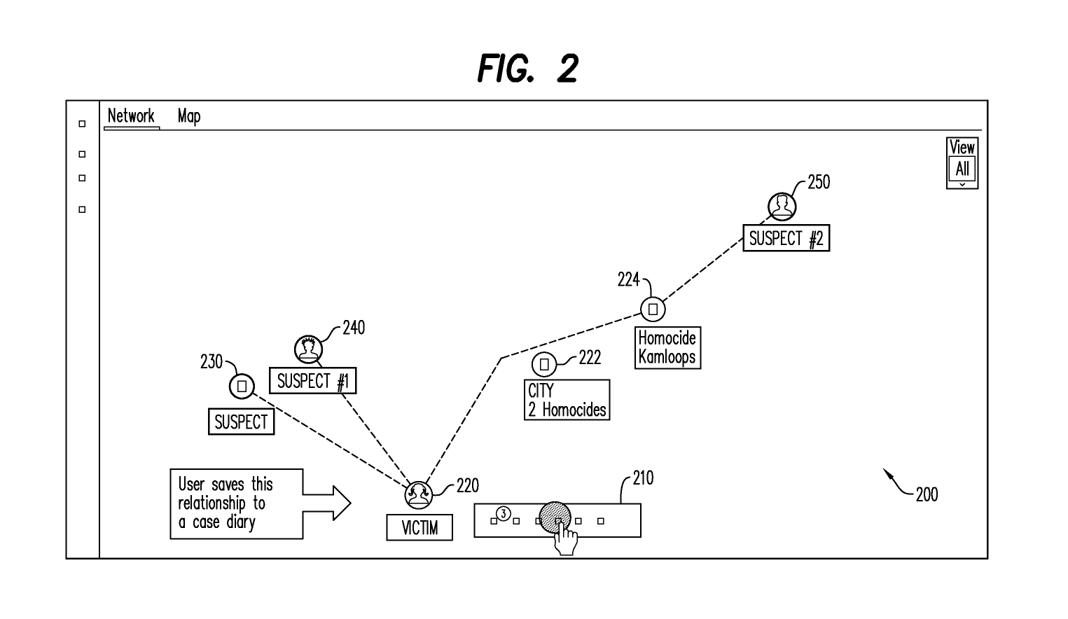

FIG. 2 illustrates context of a situation represented by a network visualization 200 in accordance with an example embodiment. In this example, a plurality of entities are represented by a plurality of nodes respectively which are connected to each other via a network diagram shown via user interface. In this example, lines within the network diagram are used to logically connect the different entities with respect to the situation. In addition, sub-nodes may also be generated between the entities further representing additional context about the situation. As a non-limiting example, the network visualization 200 may be generated by an law enforcement officer or an investigator during the course of an investigation into a crime (e.g., a homicide) by inputting commands via the user interface. Referring to FIG. 2, a victim 220 is represented by a first node and a first suspect 240 and a second suspect 250 are represented by a second and third node, respectively. Here, the visualization 200 includes a line connecting the first suspect 240 and the victim 220, as well as a line connecting the second suspect 250 and the victim.

Furthermore, additional sub-nodes 222 and 224 are displayed which represent additional context about the situation. In this example, the sub-nodes 222 and 224 include a location and an event that occurred which further link together the victim 220 and the second suspect 250. In this example, the user may add new entities to the network visualization via inputs and commands through the user interface. For example, the user may input suspects, victims, and additional context by selecting options on a user input panel 210. In this case, by selecting an option on the panel 210 the user may be provided with a blank node capable of being defined as a suspect, a victim, a sub-node, and the like. That is, the user can enter information about new entities (e.g., people, places, events, etc.) As another example, in some embodiments the entities and other information making up the network visualization may be automatically identified from a database storing information about a situation and populated into the network visualization.

As time goes by and the investigation continues to unfold, the user or the system may continue to add new suspects, victims, and events to the context of the given situation. The user may also capture the context at any point in time, for example, by selecting a save button from the panel 210 or via another known function. When the context of the situation is captured, a time-stamp may be stored along with the context to provide a point of reference for comparison with future and previous context of the same situation. This can be particularly helpful when a user would like to compare how the context of the investigation has changed or evolved over time to get a better understanding of the situation.

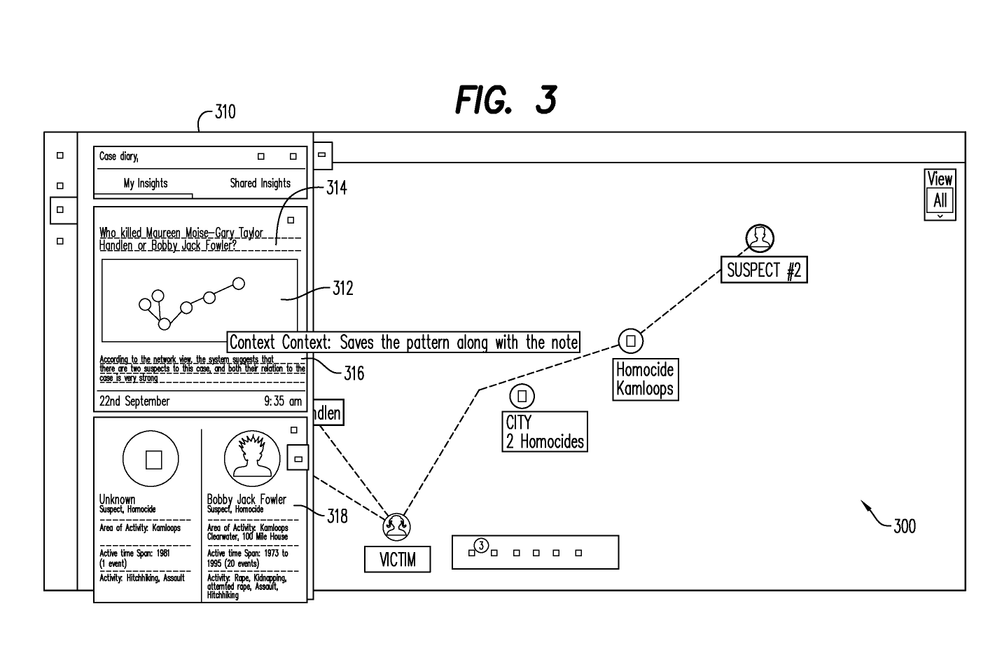

FIG. 3 illustrates a process 300 of capturing context based on the network visualization in accordance with an example embodiment. In this example, the user can save the context created through the network visualization as a pattern shown as a diagram in a panel 310. Here, the pattern represents nodes of the network visualization 200 and is displayed as a miniature pattern in window 312 of the panel 310. While one pattern is shown in 312, more than one pattern may be displayed as the network visualization evolves and additional users enter information. By saving a pattern, a first user can identify what information they input, when a second user logs into the system and adds additional information on top of the information the first user previously provided. In addition, the user may enter notes into a notepad 314 of the panel. Accordingly, the user can capture the network visualization and also capture their thoughts at the time regarding the context of the situation. By capturing the user's state of mind as well as the context of the situation, the user can easily relay this information to another person (e.g., judge, jury, attorney, etc.) during a subsequent process/trial. Furthermore, if the network diagram continues to evolve, the user can use previously captured context and notes to see how the context of the investigation has progressed.

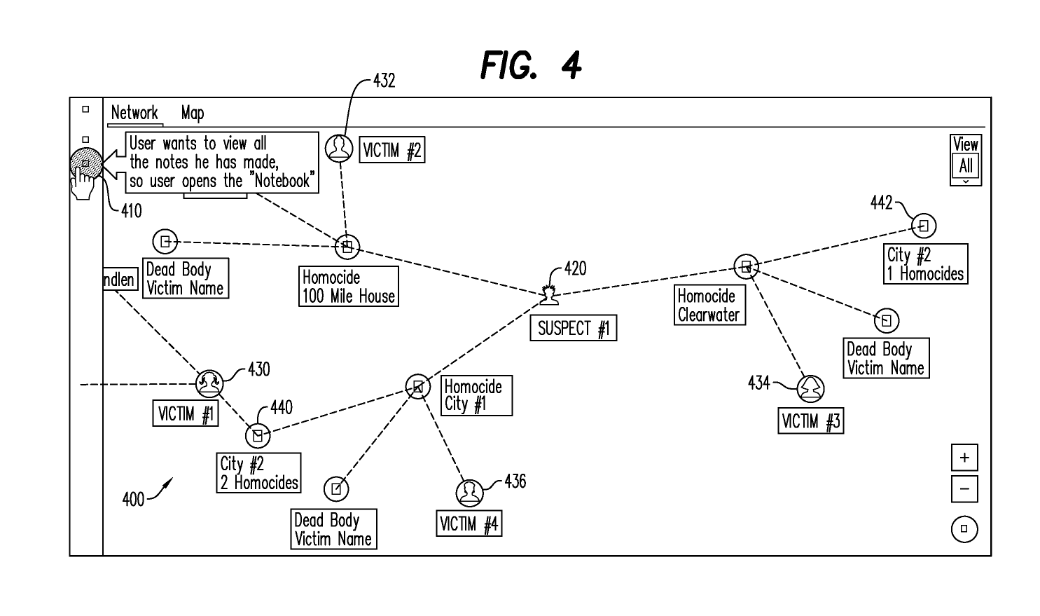

FIG. 4 illustrates subsequent context of the situation represented by an updated network visualization 400 in accordance with an example embodiment. This updated visualization is based on the previous visualization 200 but has evolved over a period of time (e.g., weeks) and now includes a different shape, size, pattern, and also includes new entities, sub-nodes, and context. Referring to FIG. 4, the visualization 400 includes a suspect 420 which corresponds to the second suspect 250 shown in FIG. 2. The user interface also shows four victims including the first victim 430, plus three other victims 432, 434, and 436. In addition, a second city 442 has been added and is represented by a sub-node along with other events (e.g., homicides) and places (e.g., addresses, cities, locations, etc.) During an investigation, the data continues to come into an investigators knowledge and this data can be added as context in the network visualization 400. Accordingly, as the investigation continues to unfold, the network visualization 400 continues to evolve.

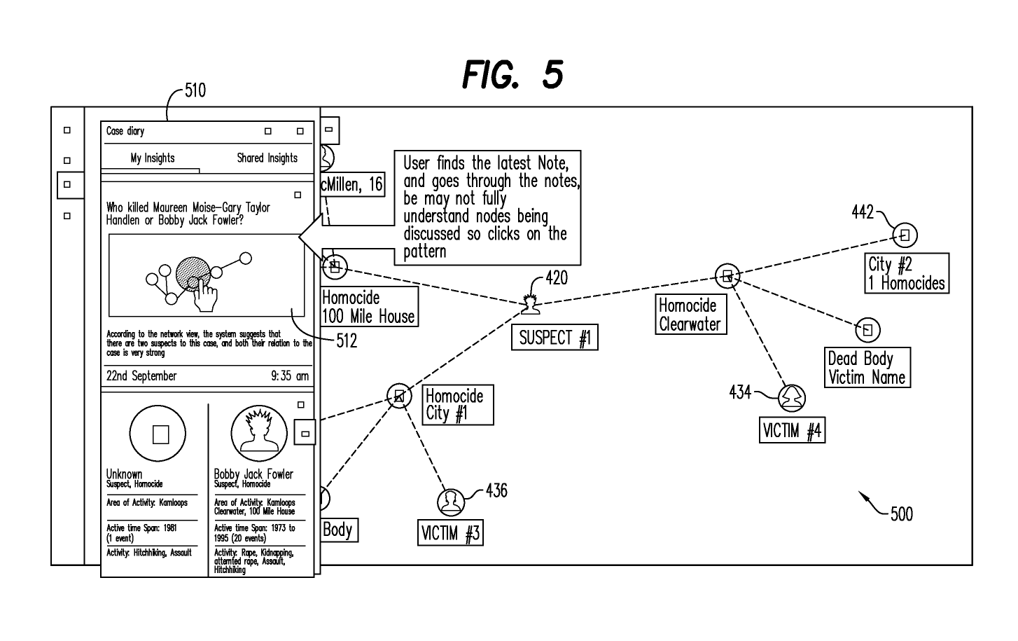

FIG. 5 illustrates a process 500 of a user selecting a node on a previously captured pattern visualization in accordance with an example embodiment. The user interface in the example of FIG. 5 illustrates the same network visualization as shown in FIG. 4 with a plurality of nodes representing a plurality of entities connected via lines and sub-nodes. Furthermore, in this example, the user interface also displays panel 510 including information such as insights, notes, shared thoughts from other users, and the like. In addition, the panel 510 includes previous patterns of the network visualization captured and shown as miniature displays within the panel 510. Accordingly, a user can quickly look at how a previous pattern existed within the network visualization, and discern between a pattern of nodes in the current network visualization based on a quick glance.

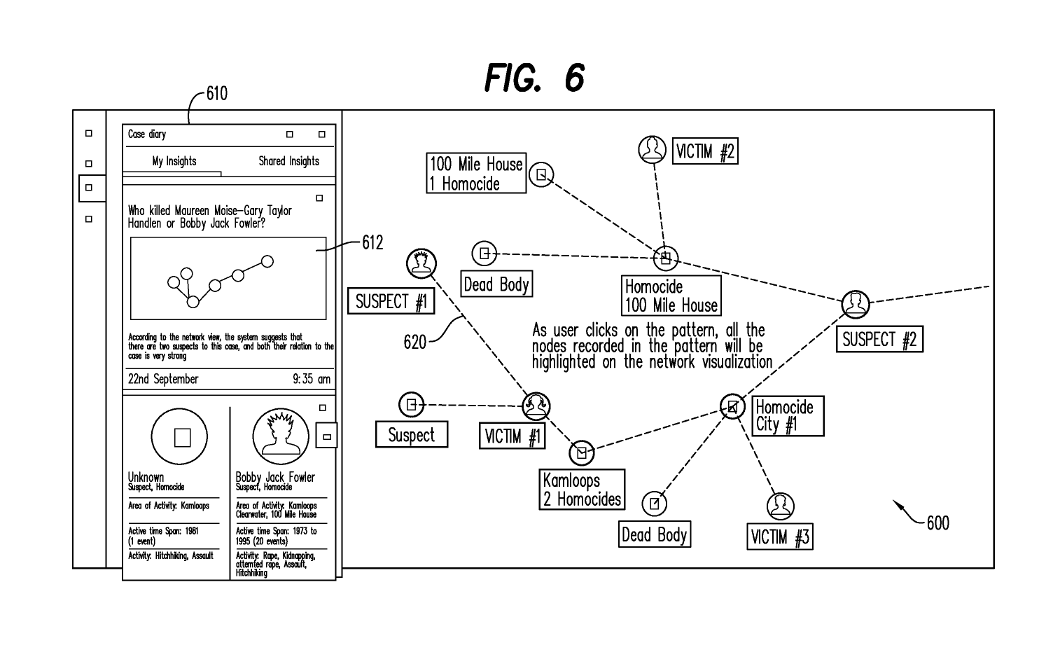

In addition, if the user desires to further distinguish between a current network visualization and a previous network visualization, the user may select a node on the miniature pattern visualization 512 shown within the panel 510 which causes the user interface to display the previous captured pattern within the network visualization as shown in FIG. 6. In particular, in FIG. 6, a pattern 620 of nodes corresponding to the network visualization 200 shown in FIG. 2, is distinguished from a current network visualization. The distinguishing may be performed by highlighting, underlining, bold, italics, colors, symbols, and/or the like. Accordingly, a user can visually distinguish the stages of the investigation over time by manipulating commands on the user interface thereby helping identify the pattern of the investigation.

As another example, as time goes by, other users may login to the system and add notes, entities, events, locations, and the like, to the network visualization. In this case, a first user may be unaware of the additional information being added. Therefore, the miniature pattern visualization may help the user understand their previous train of thought about the investigation as well as the train of thought of other users/investigators working on the case. Furthermore, when a user is away from the system for hours, days, weeks, etc., and they come back to look at the network visualization, the context may have changed significantly. Therefore, the user can select the previously saved network patterns to gain an understanding of information that has been entered by other users. That is, even though multiple users may interact with the system, a first user can identify

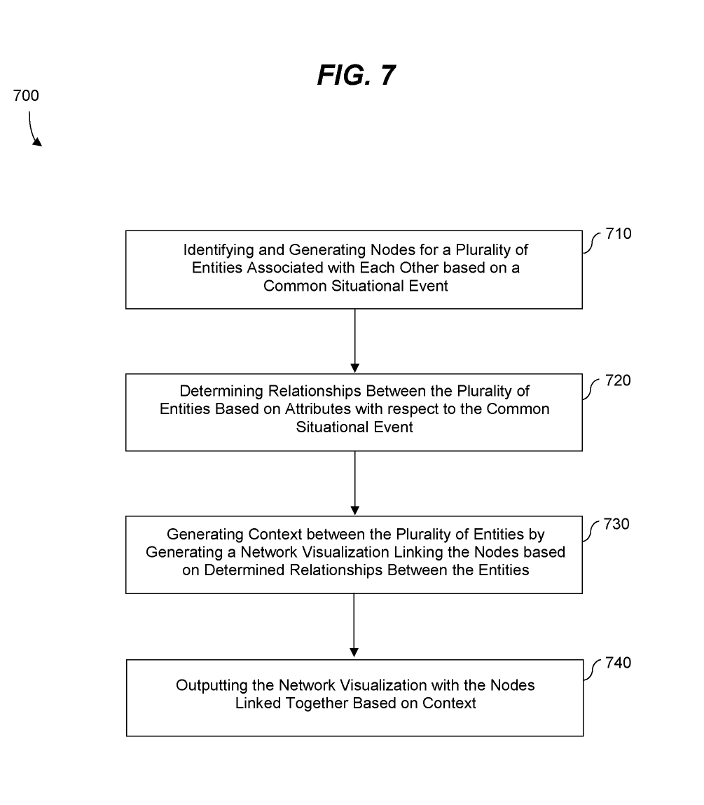

FIG. 7 illustrates a method 700 for capturing context using a network visualization in accordance with an example embodiment. For example, the method 700 may be performed by a client computing device executing a software application such as shown in the database example of FIG. 1, or in another computing environment. Referring to FIG. 7, in 710, the method includes identifying a plurality of entities that are associated with each other based on a common situational event and generating a plurality of nodes representing the plurality of entities. The common situation event may relate to an investigation and may include a historical event that has taken place at a predefined location. For example, the entities may represent a plurality of people, organizations, groups, locations, or other objects and the nodes may be used to graphically represent the entities via a user interface. Also, each entity may have a plurality of attributes such as a geographical location, one or more other events in which the entity was involved, and a period of time associated with the entity, and the like. Each node may also represent additional information about an entity associated therewith. Accordingly, a user may select a node and the method may further display additional information about the entity in a window of the user interface.

In 720, the method includes determining relationships between the plurality of entities based on the respective attributes of each of the plurality of entities with respect to the common situational event, and in 730, the method includes generating context between the plurality of entities by generating a network visualization including the plurality of nodes linked together based on the determined relationships between the plurality of entities. For example, the nodes may be connected to each other using a plurality of links, sub-nodes, images, descriptions, etc., based on context about the situation which provides further insight into the relationships between the entities with respect to the particular situation. The linking together of the nodes may generate a network diagram having a size, shape, and pattern that evolves over time as an investigation into the situation continues to evolve. The linking may also be used to represent the relationship between each entity and also geographical locations, objects, events, and the like, with respect to the situation event (e.g., historical event). In some embodiments, the generating of the context may include generating one or more sub-nodes that represents one or more shared attributes between two entities, and displaying the sub-node on the link between two nodes representing the two entities.

In 740, the method includes outputting the network visualization including the plurality of nodes linked together based on the determined relationships to a user interface. The network visualization may include the nodes linked together by lines in a distinct pattern that may continue to evolve over time. In some embodiments, the method may further include capturing the network visualization including the plurality of nodes linked together and storing the captured network visualization together with the timestamp in a database. In this example, the captured network visualization may be stored and displayed as a miniature network pattern within the user interface that also displays the network visualization. In this case, the user may select a previously captured network pattern. In response, the method may further include highlighting or otherwise distinguishing the previously captured network pattern within a display of a current network visualization. Accordingly, a user can identify quickly how the network visualization has evolved over time as a result of new evidence or new user information being added by the user or by other users.

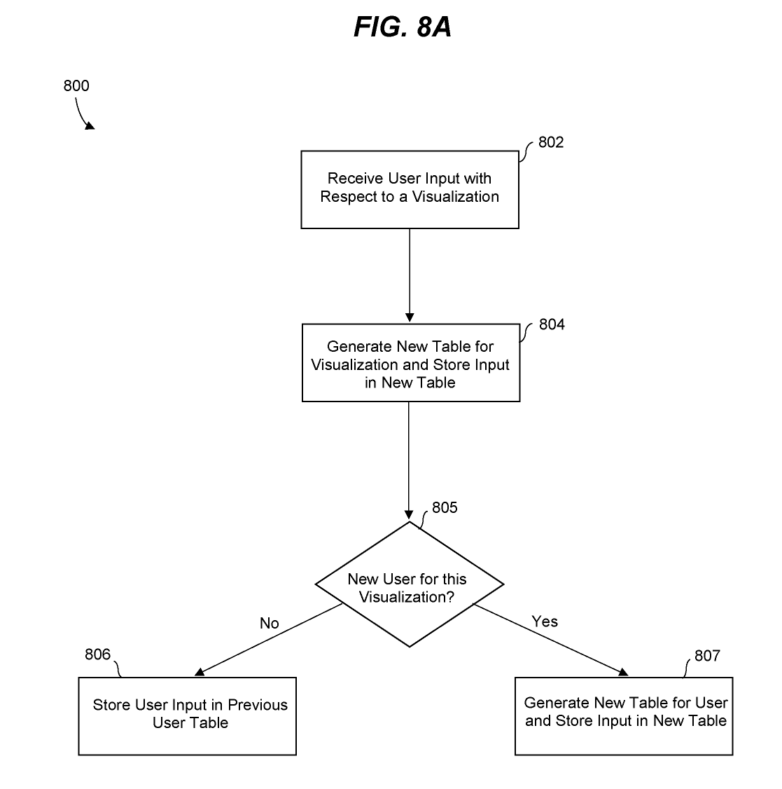

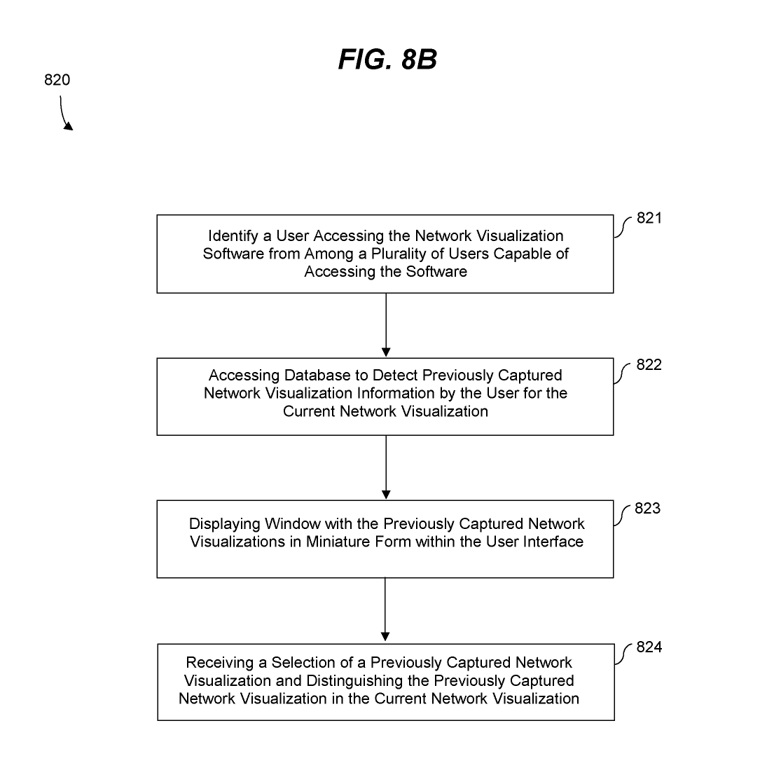

FIG. 8A illustrates a non-limiting example of a method 800 for populating a database with context from a network visualization. The method 800 may be performed by a server, a database management system, a database, a combination thereof, and the like. Referring to FIG. 8A, a user accesses a network visualization of a situational event such as an investigation. In 802, the user generates an input such as a new entity or location being added to the network visualization. In 804, the system creates a new database table for all users of the network visualization and stores the input in the newly created table. In this example, the user may not be able to edit previously saved content. Rather, different ‘states’ of the network may only be saved and revisited as and when desired. The saved states can be used by all viewers/users to understand how the visualization has changed over time. This could also be thought of as how the investigation progressed over time. In the example of FIG. 8A, the user is generate a new visualization (i.e., a first state). Meanwhile, in the example of FIG. 8B, the user revisits a previously generated visualization having a changed state.

Next, in 805 the system determines whether the user is a new user for the visualization or an existing user for the visualization. For example, the user may logon to the platform or provide an identifier or tag when accessing the network visualization user interface. If the user is an existing user for the network visualization, in 806 the system stores the user input in an existing file associated with the user. However, if the user is a new user with respect to the visualization, in 807, the system creates a new database table for the user with respect to the network visualization and stores the input in the newly created table. While this example illustrates a separate table being generated for each user and for the aggregated data provided by all users for the network visualization, the embodiments are not limited thereto and it should be appreciated that table data may be combined and may be partitioned for users. Furthermore, it is not required that the data be stored in tables at all. As another example, the data could be stored as objects, blobs, documents, XML data, and the like, within a remote or local storage.

FIG. 8B illustrates a method 820 of providing a user with previously captured context in accordance with an example embodiment. For example, the method 820 may be performed by a server, a database management system, a database, a combination thereof, and the like. In this example, a user may be subsequently accessing a context visualization software/system after previously inputting context into the system at least once before. Referring to FIG. 8B, in 821, the method identifies the user, for example, based on a network address, a login username, email address, an ID, a tag, or the like. For example, the user may be accessing the context visualization system to view an investigation or other situational event on which the user has previously provided information.

In 822, the method identifies previously captured context added by the user to the situational event associated with the network visualization being displayed. Here, the database storing the context may be accessed based on the user identification to retrieve user-specific context added to the network visualization which is stored in a user-specific table or database file in the database. In addition, the database may also access a combined context file that is an aggregation of context added by all users to the network visualization of the current investigation and stored in the database. For example, the previously captured context may include entities, relationships, and other features of the current network visualization which were previously added by the user with respect to the investigation. According to various embodiments, the previously captured context may be stored on a user-by-user basis within a database or other storage. For example, each user may be designated or assigned their own file or table within the database which identifies the context they added or commented on for a network visualization/investigation.

In 823, the visualization software displays the previously captured context within the user interface next to or in addition to the currently displayed network visualization. Here, both the previously captured context of the user and the currently displayed network visualization combined from all users are related to the same situational event but at different times of the investigation. For example, the visualization software can display previous network context added by the respective user regarding the situational event as miniature patterns in a window next to a display of a current network visualization of the situational event. In 824, the method further includes receiving a selection of a previously captured network visualization of the user and distinguishing the previously captured network visualization of the user in the current network visualization including context generated by all users. That is, the network visualization software visually distinguishes the context previously added by the user with respect to context of the current network visualization generated by all users thereby helping the user identify what changes have occurred with the investigation over time.

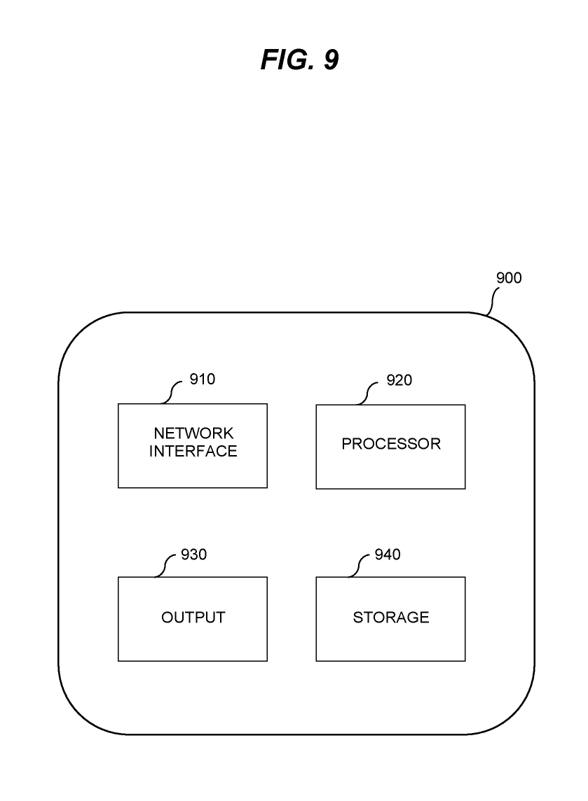

FIG. 9 illustrates a computing system 900 for capturing context using a network visualization in accordance with an example embodiment. For example, the computing system 900 may be a client device such as a tablet, a desktop computer, a smart phone, a laptop, an appliance such as a television, and the like, or a server, a cloud computing platform, and the like. Referring to FIG. 9, the computing system 900 includes a network interface 910, a processor 920, an output 930, and a storage device 940. Although not shown in FIG. 9, the computing system 900 may include other components such as a display, an input unit, a receiver/transmitter, and the like. The network interface 910 may transmit and receive data over a network such as the Internet, a private network, a public network, and the like. The network interface 910 may be a wireless interface, a wired interface, or a combination thereof. The processor 920 may include one or more processing devices each including one or more processing cores. In some examples, the processor 920 is a multicore processor or a plurality of multicore processors. Also, the processor 920 may be fixed or it may be reconfigurable. The output 930 may output data such as a user interface for network visualizations to an embedded display of the computing system 900, an externally connected display, a cloud computing environment, and the like. The storage device 940 is not limited to any particular storage device and may include any known memory device such as RAM, ROM, hard disk, and the like. The storage device 940 may store context of a situation by storing captured network visualizations and mini patterns.

According to various embodiments, the processor 920 may identify a plurality of entities associated with each other based on a common situational event and generate a plurality of nodes representing the plurality of entities. Here, each node may include a visual representation of a person, place, or thing. The processor 920 may also determine relationships between the plurality of entities based on respective attributes of each entity with respect to the common situational event, and generate context between the plurality of entities by generating a network visualization including the plurality of nodes linked together based on the determined relationships between the plurality of entities. The attributes may be geographical locations, events associated with the entity, locations, and the like. Furthermore, the output 930 may output the network visualization including the plurality of nodes linked together based on the determined relationships to a user interface for display. In addition, the processor 920 may be configured to capture the network visualization including the plurality of nodes linked together and store the captured network visualization together with the timestamp in a database. For example, the processor 920 may capture the network visualization as a miniature network pattern and display the miniature visualization within a panel of the user interface.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A computing device comprising:
a processor configured to
identify a plurality of entities associated with each other based on a common situational event and generating a plurality of nodes representing the plurality of entities,
determine relationships between the plurality of entities based on respective attributes of each entity with respect to the common situational event, and
generate context between the plurality of entities by generating a network visualization including the plurality of nodes linked together based on the determined relationships between the plurality of entities; and
an output configured to output the network visualization including the plurality of nodes linked together based on the determined relationships to a user interface.

2. The computing device of claim 1, wherein the processor is further configured to capture the network visualization including the plurality of nodes linked together and store the captured network visualization together with the timestamp in a database.

3. The computing device of claim 2, wherein the processor stores the captured network visualization as a miniature network pattern within a panel of a user interface displaying the network visualization.

4. The computing device of claim 1, wherein the common situational event comprises a historical event that has taken place at a predefined location, and the relationships include people who are associated with the historical event.

5. The computing device of claim 1, wherein the plurality of entities comprise a plurality of people, respectively, and each person is represented by a respective node among the plurality of nodes.

6. The computing device of claim 5, wherein the attributes of each person comprise at least one of a geographical location, one or more other events in which the person was involved, and a period of time associated with the person.

7. The computing device of claim 1, wherein the processor is further configured to generate a sub-node that represents one or more shared attributes between two entities, and display the sub-node on the link between two nodes representing the two entities.

8. The computing device of claim 1, wherein the processor is further configured to detect a selection of a node via the user interface, and in response, display additional information about the entity represented by the selected node.

9. A computer-implemented method comprising:
identifying a plurality of entities that are associated with each other based on a common situational event and generating a plurality of nodes representing the plurality of entities;
determining relationships between the plurality of entities based on respective attributes of each of the plurality of entities with respect to the common situational event;
generating context between the plurality of entities by generating a network visualization including the plurality of nodes linked together based on the determined relationships between the plurality of entities; and
outputting the network visualization including the plurality of nodes linked together based on the determined relationships to a user interface.

10. The computer-implemented method of claim 9, further comprising capturing the network visualization including the plurality of nodes linked together and storing the captured network visualization together with the timestamp in a database.

11. The computer-implemented method of claim 10, wherein the captured network visualization is stored as a miniature network pattern within a panel of a user interface displaying the network visualization.

12. The computer-implemented method of claim 9, wherein the common situational event comprises a historical event that has taken place at a predefined location, and the relationships include people who are associated with the historical event.

13. The computer-implemented method of claim 9, wherein the plurality of entities comprise a plurality of people, respectively, and each person is represented by a respective node among the plurality of nodes.

14. The computer-implemented method of claim 13, wherein the attributes of each person comprise at least one of a geographical location, one or more other events in which the person was involved, and a period of time associated with the person.

15. The computer-implemented method of claim 9, wherein the generating the context further comprises generating a sub-node that represents one or more shared attributes between two entities, and displaying the sub-node on the link between two nodes representing the two entities.

16. The computer-implemented method of claim 9, further comprising receiving a selection of a node via the user interface, and in response, displaying additional information about the entity represented by the selected node.

17. A non-transitory computer readable medium having stored therein instructions that when executed cause a computer to perform a method comprising:
identifying a plurality of entities that are associated with each other based on a common situational event and generating a plurality of nodes representing the plurality of entities;
determining relationships between the plurality of entities based on respective attributes of each of the plurality of entities with respect to the common situational event;
generating context between the plurality of entities by generating a network visualization including the plurality of nodes linked together based on the determined relationships between the plurality of entities; and
outputting the network visualization including the plurality of nodes linked together based on the determined relationships to a user interface.

18. The non-transitory computer-readable medium of claim 17, wherein the method further comprises capturing the network visualization including the plurality of nodes linked together and storing the captured network visualization together with the timestamp in a database.

19. The non-transitory computer-readable medium of claim 17, wherein the common situational event comprises a historical event that has taken place at a predefined location, and the relationships include people who are associated with the historical event.

20. The non-transitory computer-readable medium of claim 17, wherein the plurality of entities comprise a plurality of people, respectively, and each person is represented by a respective node among the plurality of nodes.
